(19) United States
(12) Patent Application Publication
(10) Pub. No.: US 2007/0037568 A1
(43) Pub. Date: Feb. 15, 2007

(54) Networked wireless devices for local tracking and interaction

(76) Inventors: Robert Warner, Holmdel, NJ (US); Jack Winters, Middletown, NJ (US)

Correspondence Address: MATHEWS, SHEPHERD, MCKAY, & BRUNEAU, P.A., 29 THANET ROAD, SUITE 201, PRINCETON, NJ, 08540, US

(21) Appl. No.: 11/504,789

(22) Filed: Aug. 15, 2006

Related U.S. Application Data
(60) Provisional application No. 60/708,212, filed on Aug. 15, 2005.

(51) Int. Cl. H04Q 7/20

(52) U.S. Cl. 455/422.1; 370/346

(57) ABSTRACT

The present invention provides one or more powered wireless transceivers and/or one or more passive wireless transceivers networked to one another, a method for making same and the method of using these devices for locating, tracking and identifying each other, the products in which they are implemented and/or the person, animal or thing holding, maintaining or transporting the device with possible interaction among the devices. Specifically, the invention concerns keeping groups of devices within a certain range of one another, even as they may move around.

### CROSS REFERENCE TO RELATED APPLICATION

This application claims the benefit of U.S. Provisional Patent Application No. 60/708,212, filed Aug. 15, 2005, the entirety of which is hereby incorporated by reference into this application.

### BACKGROUND OF THE INVENTION

1. Field of the Invention

The present invention provides one or more powered wireless transceivers and/or one or more passive wireless transceiver devices networked to one another, a method for making same and the method of using these devices for locating, tracking and identifying each other, the products in which they are implemented and/or the person, animal or thing holding, maintaining or transporting the device.

2. Description of Related Art

A radio-frequency identification (RFID) transceiver is a device that receives an electronic signal, generates a response signal, and then transmits the response signal. RFID transceivers have been used to locate, identify and track individual merchandise palettes, individual shipping containers on a palette or individual items within a container, on a retailer shelf or in use by an end user. RFID transceivers have been used to locate, identify and track individual persons, such as children, and individual animals by placing readers at the entrances and exits to rooms, buildings and other contained areas. These implementations have been effective at controlling and policing the movement of the persons or animals in and out of these contained areas.

A global positioning satellite (GPS) receiver is a device that receives an electronic signal from three or more GPS satellites to determine its global position. GPS receivers in conjunction with other satellite or terrestrial means have been used to locate, identify and track individual shipping containers, individual trucks or other transportation means. They have been used to locate, identify and track individual persons, such as children, and individual animals when they are not in contained areas. Using GPS for tracking has many limitations, including the required line of sight to get a positioning, the need to translate longitude and latitude into usable terms and the relatively high cost. Trucks, containers, assets, persons or animals in buildings, in cities with high buildings, in vehicles and in dense forests are not able to establish, and therefore communicate, their global position. In addition to the high cost of implementing a GPS-based tracking system, there is also difficulty and cost associated with translating longitude and latitude readings into a format that is useful to a tracking operator or person.

Conventional tracking methods and technology have focused on the use of RFIDs for controlling and policing the movement of individual merchandise palettes, individual shipping containers, individual items within a container, on a retailer shelf or in use by an end user or individual persons or individual animals in and out of these contained areas and the use of GPS receivers in conjunction with other satellite or terrestrial means to locate, identify and track individual shipping containers, individual trucks or other transportation means or individual persons or individual animals when they are not in contained areas and have not focused on controlling and policing the movement of these persons, animals or things when they are all located, traveling or moving together.

U.S. Pat. No. 6,868,333 describes a group interaction system comprising a plurality of vehicle navigation systems that are capable of communicating with one another, displaying the location of other vehicle navigation systems in a group, and receiving selection of certain vehicle navigation systems in the group and selection of an application for interaction among the selected vehicle navigation systems.

U.S. Pat. No. 6,788,199 describes a system and method for locating objects such as people, pets, and personal articles whereby a transceiver is attached to the person, animal, or item to be tracked and a handheld locator device is employed to transmit a locator signal containing an address code to the transceiver to determine the distance and/or direction of the transceiver from the user's location.

U.S. Pat. No. 6,069,570 describes a low cost, low power, non-voice communication system that includes a pager, a control processor, a GPS receiver and a cell phone for determining the location or states of an asset or a class of assets in a larger array of assets such as a tractor trailer, a container, construction equipment, and service vehicles, which during normal operation, is in a low power or sleep mode.

U.S. Pat. No. 5,588,005 describes two modes of communication for asset tracking units involving a primary mode of communication between a central station and the individual tracking units, usually through a satellite link, and a secondary or local area network (LAN) mode, in which a subset of tracking units communicate with each other to conserve power or when their batteries are too weak to support communication with the central station.

The above described patents concern using wireless technology for the specific purpose of communicating between vehicle navigation systems, to find the distance and direction of a certain object, and to supplement a GPS-based tracking system for power conservation.

It is desirable to provide a system of networked wireless devices for locating, tracking, identifying, and interacting with each other.

### SUMMARY OF THE INVENTION

The present invention provides one or more powered wireless transceivers and/or one or more passive wireless transceivers networked to one another, a method for making same and the method of using these devices for locating, tracking and identifying each other, the products in which they are implemented and/or the person, animal or thing holding, maintaining or transporting the device with possible interaction among the devices. Specifically, this invention is directed to keeping groups of devices within a certain range of one another, even as they may move around for common benefit. In particular, the network is interconnected such that there is always a path from one user to another, through one or more hops, where the distance of each hop is less than a predetermined minimum. The distance of each hop is determined by the wireless technology deployed. If one or more members of the group are subject to disconnection, i.e., their power level, signal to noise ratio (SNR), or the like, falls below a threshold that is required for wireless connectivity, then an alarm notifies a master network node and/or the slave node subject to disconnection and/or all nodes that a disconnect may have occurred and which node is subject to disconnection. By allowing a disconnect alarm at a predetermined power level, SNR, and the like, above that for which complete disconnection would occur, the master node and/or unaffected connected nodes can send a data or voice (local Push To Talk) message to the nodes subject to disconnection to avoid or ameliorate the disconnection. A disconnection would deprive the affected node(s) of voice, data, video or other communication services with or through the unaffected node(s). A disconnection would also deprive the remaining connected node(s) of voice, data, video or other communication services with or through the affected nodes. A disconnection could deprive all the node(s) of voice, data, video or other communication service with a third party wireless or satellite link if one or more of the connected nodes were individually or in collaborative fashion wirelessly linked to the third party.

Examples of potential groups with wirelessly connected devices include, but are not limited to, parents and children walking together as with shopping, groups of hikers, teachers and students on field trips or moving from class to class, vehicles traveling to the same location, military vehicles and/or troops on maneuvers, bicyclists on tour, runners on a set path, convoys of trucks or buses, motorcycle clubs and groups of marchers. Examples of third party wireless or satellite links include, but are not limited to, satellite voice or data networks, cellular, WiMAX or other wireless metropolitan area network (WMAN) voice and data networks, satellite or terrestrial video services, satellite or terrestrial audio services, and satellite or terrestrial information services.

One embodiment of the wireless network of the present invention comprises a radio frequency identification (RFID) reader embedded within another electronics device and passive radio frequency identification (RFID) transceivers embedded within other electronics devices for one way wireless connectivity. A second embodiment of the wireless network of the present invention comprises radio frequency identification (RFID) readers and passive radio frequency identification (RFID) transceivers embedded within electronics devices for two way wireless connectivity. A third embodiment of the wireless network of the present invention comprises radio frequency identification (RFID) readers and active radio frequency identification (RFID) transceivers embedded within electronics devices for two way wireless connectivity. A fourth embodiment of the wireless network of the present invention comprises Bluetooth or other wireless personal area network (WPAN) modules within electronics devices for two way wireless connectivity. A fifth embodiment of the wireless network of the present invention comprises WiFi or other wireless local area network (WLAN) modules within electronics devices for two way wireless connectivity. A sixth embodiment of the wireless network of the present invention comprises WiMAX or other wireless metropolitan area network (WMAN) modules within electronics devices for two way wireless connectivity. A seventh embodiment of the wireless network of the present invention comprises a combination of RFID, WPAN, WLAN, WMAN modules within electronics devices for two way wireless connectivity with user selectable power, range, data rate and application options. An eighth embodiment of the wireless network of the present invention comprises an RFID, WPAN, WLAN, or WMAN module with user/group-controlled mesh networking capability within electronics devices for two way wireless connectivity with range that encompasses an extended group. A ninth embodiment of the wireless network of the present invention comprises an RFID, WPAN, WLAN, or WMAN module with third party satellite or wireless connectivity and with user/group-controlled mesh networking capability within electronics devices for two way wireless connectivity with range that encompasses an extended group. A tenth embodiment of the wireless network of the present invention comprises an RFID, WPAN, WLAN, or WMAN module with third party satellite or wireless connectivity that can be used in a collaborative fashion with the other grouped nodes to download data or video more efficiently and/or effectively than possible individually and with user/group-controlled mesh networking capability within electronics devices for two way wireless connectivity with range that encompasses an extended group. In each embodiment, there are trade offs between cost, power, range and possible data rates and applications.

In all cases, the present invention can be used for locating, identifying and tracking of groups of in situ electronics devices. Alternatively, the present invention can be used for locating, identifying and tracking of the electronics device throughout the logistics process.

### BRIEF DESCRIPTION OF THE DRAWINGS

FIG. 1 is a schematic diagram of an embodiment of the wireless device of the present invention in which nodes are connected in a path.

FIG. 2 is a schematic diagram of an alternate embodiment of the wireless device of the present invention in which nodes are connected in an ad hoc network.

FIG. 3 is a schematic diagram of an alternative embodiment of the wireless device of the present invention in which nodes are connected in an ad hoc network with two or more of the nodes having third party satellite or wireless connectivity that can be used in a collaborative fashion to increase overall user bandwidth.

FIG. 4 is a schematic diagram of an alternate embodiment of the wireless device of the present invention in which users are connected in a star network.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

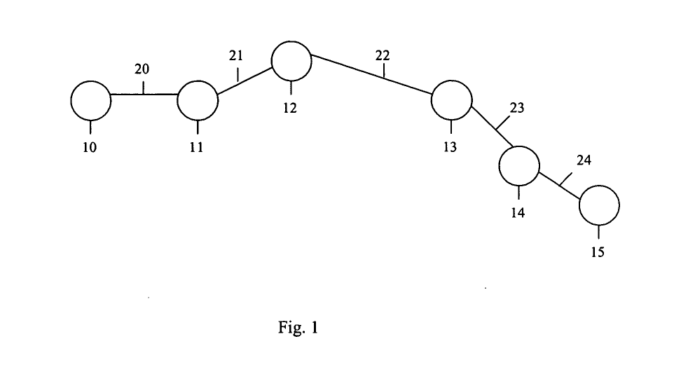

FIG. 1 shows a series of nodes traveling on a path. Nodes 10, 11, 12, 13, 14, and 15 are sequentially arranged, with node 10 communicating with node 11 via link 20, node 11 communicating with node 12 via link 21, node 12 communicating with node 13 via link 22, node 13 communicating with node 14 via link 23, and node 14 communicating with node 15 via link 24. If links 20 to 24 have low enough propagation loss (note that, although the propagation loss is determined for links between nodes, it can be associated with each node as well), all the nodes are interconnected, and each node can communicate with any other node through multiple hops. It will be appreciated that although the propagation loss is determined for links between nodes, it can be associated with each node as well. However, if, for example, nodes 12 and 13 become further separated while the nodes are traveling, for example, to the right in FIG. 1, then the propagation loss can increase beyond a predetermined threshold, which may be set significantly higher than that required for communication. At that point, nodes 12 and 13 may still be able to communicate (if the propagation loss is higher than that required for communication), and can, for example, send signals to indicate to nodes 13 to 15 to slow down, while nodes 10 to 12 continue to travel at the same pace so that nodes 12 and 13 become closer together. Additional data intensive communication means beyond simple signaling are possible in accordance with the teachings of the present invention. Similarly, if the propagation loss between nodes 12 and 13 becomes so large that these nodes can no longer communicate, then node 13 could stop and signal nodes 14 and 15 to also stop while node 12 could continue traveling while signaling nodes 10 and 11 to catch up. Thus, in either case, the group of nodes could stay together without losing connectivity. Any one of the nodes can also have third party satellite or wireless connectivity, which would permit signals to be sent to all nodes to move, for example, at the appropriate speed to maintain or enable connectivity. The signals could also indicate to one or more of nodes 10-15 to travel at a predetermined speed, velocity, or direction, or to a predetermined location, in order to avoid disconnection, to ameliorate the connection, or to enable reconnection.

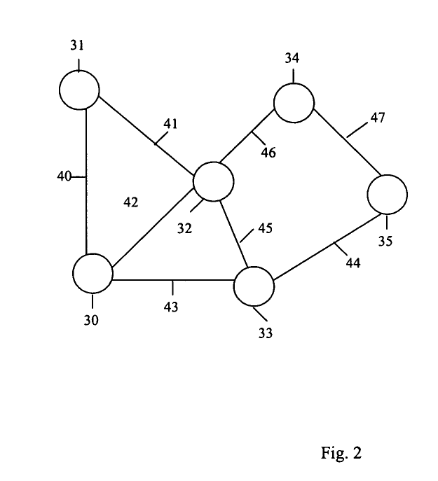

FIG. 2 illustrates an embodiment of the present invention showing groups in two dimensions that may be traveling. Nodes 30 to 35 are interconnected via perspective links 40 to 47. Although all nodes are not directly interconnected to every other node, the network of nodes is fully interconnected, such that any node can communicate to any other node via one or more links or hops. For example, at least three of the nodes 30 to 35 are connected to one another. Any one of the nodes can have third party satellite or wireless connectivity. Thereafter, if the propagation loss of the links increases as the nodes move to the point where the network is no longer fully interconnected at a predetermined propagation loss, then the disconnected nodes can be signaled to move back towards the main group and meet at a given location, and the like. Also, if any nodes are completely disconnected such that communication with the main group is no longer possible, then the disconnected nodes can be signaled to meet at a predetermined location. Alternatively, the disconnected nodes can emit a loud tone to help in locating them, GPS can be used to inform the group where the last connected location was to reconnect, or the signal strength from a central node can be used to determine the direction that the disconnected nodes need to move to reconnect. Accordingly, the group of nodes can be kept together and any wandering nodes can be quickly reconnected.

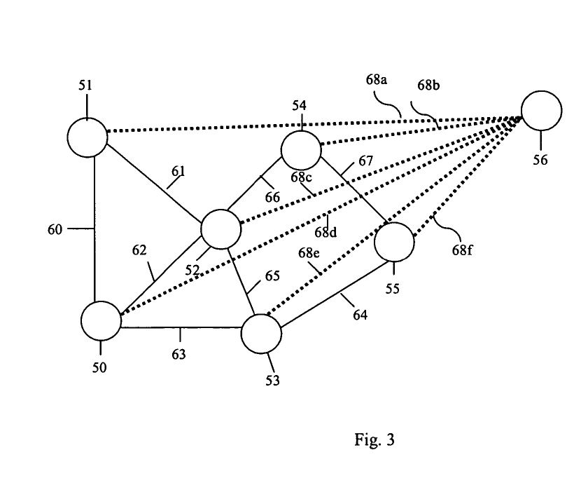

FIG. 3 shows an embodiment of the present invention showing groups in two dimensions that may be traveling, with two or more of the nodes having third party satellite or wireless connectivity that can be used in a collaborative fashion with the other grouped nodes to download data or video more efficiently and/or effectively than possible individually. Nodes 50 to 55 are interconnected via respective links 60 to 67. Nodes 50 to 55 can be used in a collaborative fashion to download data or video more efficiently and/or effectively than possible individually from third party node 56 via respective communication paths 68a-68f. Although all nodes are not directly interconnected to every other node, the network of nodes is fully interconnected, such that any node can communicate to any other node via one or more links/hops and shared units of downloaded data.

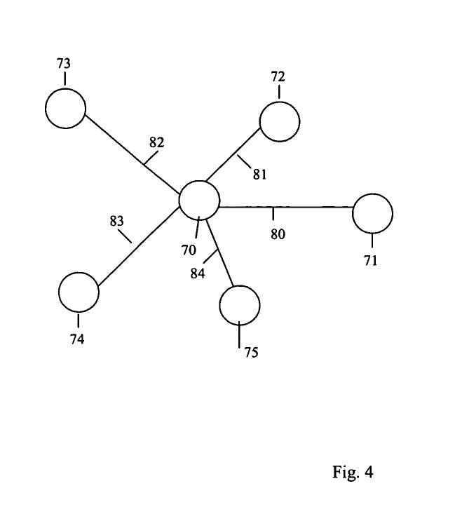

FIG. 4 shows another embodiment in which a star network is used. In this embodiment, node 70 is a central or mother node, which communicates with the satellite or child nodes 71 to 75 via respective links 80 to 84. As shown in FIG. 2, if the network becomes disconnected, then both the child node and mother node can be informed, with the various options as listed above.

Nodes 10-15, 30-35, and 70-75 can be passive RFID transceivers and/or active radio RFID transceivers. The RFID transceivers can provide one-way or two-way wireless connectivity. Nodes 10-15, 30-35 and 70-75 can be RFID readers.

In one embodiment, nodes 10-15, 30-35, and 70-75 can comprise Bluetooth or other wireless personal area network (WPAN) modules for two-way wireless connectivity.

In one embodiment, nodes 10-15, 30-35, and 70-75 can comprise WiFi or other wireless local area network (WLAN) modules for two-way wireless connectivity.

In one embodiment, nodes 10-15, 30-35, and 70-75 can comprise WiMAX or other wireless metropolitan area network (WMAN) modules for two-way wireless connectivity.

In one embodiment, nodes 10-15, 30-35, and 70-75 can comprise a combination of RFID, WPAN, WLAN, WMAN modules for two way wireless connectivity with user selectable power, range, data rate and application options.

In one embodiment, nodes 10-15, 30-35, and 70-75 can comprise an RFID, WPAN, WLAN, or WMAN module with user/group-controlled mesh networking capability for two-way wireless connectivity with range that encompasses an extended group.

In one embodiment, nodes 70-75 can comprise an RFID, WPAN, WLAN, or WMAN module with third party satellite or wireless connectivity and with user/group-controlled mesh networking capability for two-way wireless connectivity with range that encompasses an extended group.

In one embodiment, nodes 70-75 can comprise third party satellite or wireless connectivity and with user/group-controlled mesh networking capability within electronics devices for two way wireless connectivity with range that encompasses an extended group.

In one embodiment nodes 70-75 can comprise an RFID, WPAN, WLAN, or WMAN module with third party satellite or wireless connectivity that can be used in a collaborative fashion with the other grouped nodes to download data or video more efficiently and/or effectively than possible individually and with user/group-controlled mesh networking capability within electronics devices for two way wireless connectivity with range that encompasses an extended group.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. A radio frequency identification (RFID) system comprising:
a plurality of nodes networked to one another with one or more communication links;
means for communicating between said nodes in which each of said nodes can communicate with any other node using one or more of said communication links by sending one or more signals; and
means for determining a propagation loss of each said nodes,
wherein if said propagation loss for any of said nodes is determined as greater than a threshold, sending said one or more signals to one or more of said nodes to avoid disconnection or enable reconnection.

2. The RFID system of claim 1 wherein said one or more signals indicates to said one or more nodes to travel at a predetermined speed, velocity, or direction, or to a predetermined location.

3. The RFID system of claim 1 wherein said plurality of nodes are connected sequentially.

4. The RFID system of claim 1 wherein said plurality of nodes are connected in an ad hoc network.

5. The RFID system of claim 1 wherein any of said one or more nodes can have satellite or wireless connectivity.

6. The RFID system of claim 1 wherein two or more or said nodes have satellite or wireless connectivity which can be connected with at least one group of said nodes.

7. The RFID system of claim 1 wherein one of said nodes is a central node and others of said nodes are child nodes, wherein said central node communicates with said child nodes using said means for communicating between said nodes.

8. The RFID system of claim 1 wherein said nodes are active wireless RFID transceivers and/or passive wireless RFID transceivers.

9. The RFID system of claim 1 wherein said nodes comprise one or more RFID readers and one or more passive RFID transceivers and said means for communicating between said nodes provides one way wireless connectivity.

10. The RFID system of claim 1 wherein said nodes comprise one or more RFID readers and one or more passive RFID transceivers and said means for communicating between said nodes provides two-way wireless connectivity.

11. The RFID system of claim 1 wherein said nodes comprise one or more RFID readers and one or more active RFID transceivers and said means for communicating between said nodes provides two-way wireless connectivity.

12. The RFID system of claim 1 wherein said nodes comprise wireless personal area network (WPAN) modules and said means for communicating between said nodes provides two-way wireless connectivity.

13. The RFID system of claim 1 wherein said nodes comprise wireless local area network (WLAN) modules and said means for communicating between said nodes provides two-way wireless connectivity.

14. The RFID system of claim 1 wherein said nodes comprise wireless metropolitan area network (WMAN) modules and said means for communicating between said nodes provides two-way wireless connectivity.

15. The RFID system of claim 1 wherein said nodes include user selectable power, range, data rate, or application options.

16. The RFID system of claim 1 wherein said nodes comprise RFID, WPAN, WLAN and WMAN modules and said means for communicating between said nodes provides two-way wireless connectivity.

17. The RFID system of claim 17 wherein said nodes include user or group controlled mesh networking.

18. The RFID system of claim 17 wherein said nodes have a range for an extended group of said nodes.

19. The RFID system of claim 1 wherein one of said nodes is a third-party satellite.

20. The RFID system of claim 20 wherein said nodes have a range for an extended group of said nodes.

21. The RFID system of claim 20 wherein said third-party satellite can download data or video.

22. A method of locating, identifying and tracking nodes of a radio frequency identification (RFID) system comprising the steps of:
providing a plurality of nodes networked to one another with one or more communication links;
communicating between said nodes using said communication links in which each of said nodes can communicate with any other node using one or more of said communication links by sending one or more signals; and
determining a propagation loss of each said nodes,
wherein if said propagation loss for each said nodes is determined as greater than a threshold, sending said one or more signals to one or more of said nodes to avoid disconnection or enable reconnection.

23. The method of claim 22 wherein said one or more signals indicates to said one or more nodes to travel at a predetermined speed, velocity, or direction, or to a predetermined location.

24. The method of claim 22 wherein said plurality of nodes are connected sequentially.

25. The method of claim 22 wherein said plurality of nodes are connected in an ad hoc network.

26. The method of claim 22 wherein any of said one or more nodes can have satellite or wireless connectivity.

27. The method of claim 22 wherein two or more or said nodes have satellite or wireless connectivity which can be connected with at least one group of said nodes.

28. The method of claim 22 wherein one of said nodes is a central node and others of said nodes are child nodes, wherein said central node communicates with said child nodes.

29. The method of claim 22 wherein said nodes are active wireless transceivers and/or passive wireless transceivers.

30. The method of claim 22 wherein said nodes comprise one or more RFID readers and one or more passive RFID transceivers, said one or more RFID readers and one or more passive RFID transceivers communicating with one way wireless connectivity.

31. The method of claim 22 wherein said nodes comprise one or more RFID readers and one or more passive RFID transceivers, said one or more RFID reader and one or more passive RFID transceivers communicating with two-way wireless connectivity.

32. The method of claim 22 wherein said nodes comprise one or more RFID readers and one or more active RFID transceivers, said one or more RFID reader and one or more passive RFID transceivers communicating with two-way wireless connectivity.

33. The method of claim 22 wherein said nodes comprise wireless personal area network (WPAN) modules, said WPAN modules communicating with two-way wireless connectivity.

34. The method of claim 22 wherein said nodes comprise wireless local area network (WLAN) modules, said WLAN modules communicating with two-way wireless connectivity.

35. The method of claim 22 wherein said nodes comprise wireless metropolitan area network (WMAN) modules, said WMAN modules communicating with two-way wireless connectivity.

36. The method of claim 22 wherein said nodes include user selectable power, range, data rate, or application options.

37. The method of claim 22 wherein said nodes comprise RFID, WPAN, WLAN and WMAN modules, said RFID, WPAN, WLAN and WMAN modules communicating with two-way wireless connectivity.

38. The method of claim 37 wherein said nodes include user or group controlled mesh networking.

39. The method of claim 37 wherein said nodes have a range for an extended group of said nodes.

40. The method of claim 37 wherein one of said nodes is a third-party satellite.

41. The method of claim 40 wherein said nodes have a range for an extended group of said nodes.

42. The method of claim 40 wherein said third-party satellite can download data or video.

43. The method of claim 22 wherein each of said nodes is associated with a person, animal or thing holding, maintaining or transporting said node.
